(19) United States
(12) Patent Application Publication
(10) Pub. No.: US 2007/0048704 A1
(43) Pub. Date: Mar. 1, 2007

(54) Advertising method using story characters

(76) Inventor: Kathleen M. Tejera, Stafford, VA (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/216,218

(22) Filed: Aug. 31, 2005

(51) Int. Cl. G09B 19/00

(52) U.S. Cl. 434/236

(57) ABSTRACT

A method of advertising personal hygiene products is disclosed. Uniquely designated characters are presented in a series of entertaining children's stories. In general, the designated characters may represent hygiene and/or grooming difficulties and the stories describe effective methods to overcome such difficulties. The method encourages the purchase of products to overcome such difficulties in real life. The invention further describes a method to teach and encourage children of all ages to learn and practice good personal hygiene by creating designated characters in a series of stories representing specific hygiene and/or grooming difficulties, relating those characters to real life difficulties, and describing appropriate use of products aimed at such difficulties.

### BACKGROUND OF THE INVENTION

1. Field of the Invention

This invention generally relates to the field of advertising and, in particular, to a method of advertising products for children and adults by relating characters in a story to specific issues and identifying products or methods to overcome such issues.

2. Background of the Prior Art

Traditional advertising in printed media usually includes only a single banner or poster illustrating a product or service. Printed advertisements tend to be passive and isolated making it difficult to engage the viewer emotionally or intellectually. Such advertising lacks the attention grabbing quality of story telling or animation and fails to fully take in an interested viewer.

Several patents have been issued for methods that attempt to integrate commercial advertising into program content. For example, U.S. Pat. No. 6,859,936 to Makowski, Jr. et al. describes a method and system for incorporating thematic content from a television program into advertisements. U.S. Pat. No. 6,883,430 to Hollander describes a packaging method that includes advertisement related to the product directly on the packaging. U.S. Pat. No. 5,810,601 to Williams describes an instructional display for dental hygiene instruction. While related to a specific function, it is not directed to a specific, identified product.

Additionally, there are several pending applications directed to advertising, many specifically including advertising directly in video games, on the Internet, or other multimedia devices. See U.S. Patent Application Publication Nos. US 2002/0022516; US 2002/0059640; US 2004/0180708; US 2004/0193483; US 2005/0084836. Nearly all are directed to various electronic media for advertising.

Various children's books have been created that include plural pages having one or a combination of (1) a textual story for the child to read or (2) individual pictures on the pages. Those books, however, do not even attempt to exploit the readers' interest to affect the reader's purchase of goods or services, other than the books themselves.

While the prior art may be effective to describe systems and methods to display advertising in a variety of media, none use uniquely designated characters in a series of entertaining children's stories to teach the children how to perform a specific activity and simultaneously advertises a product or service for use in that activity. None of the prior art discloses a method and system to advertise identified products in the context of a children's story.

### SUMMARY OF THE INVENTION

The present invention comprises a method and system for incorporating thematic content from a children's story into product or service advertisements. The present invention also comprises a method and system for increasing the viewership and effectiveness of advertisements by incorporating such thematic content into product or service advertisements within the story.

In one embodiment of the invention, the protagonists of the story encounter a problem. In the course of the story the protagonists develop or discover a solution to the problem, which solution may involve a product. The commercial containing thematic content involves the use of the product by the protagonist to solve the problem encountered.

The method and system of the present invention will typically be embodied in printed form. In some embodiments, the thematic content may be embodied in video form. It is anticipated that the content can be embodied in various forms of media. It is, therefore, an object of the present invention to provide a method of advertising using story characters that avoids the disadvantages of the prior art.

It is an object of the present invention to provide a story in which the reader can empathize with the characters who encounter difficulties in the story that relate to or are analogous to real world difficulties. A related object of the present invention is to provide a story in which the protagonist develops or discovers a solution to difficulties in the story that relate to or are analogous to real world difficulties. A further related object of the present invention is to provide a story or series of stories that advertises a product or service as the solution to difficulties in the stories that relate to or are analogous to real world difficulties.

It is another object of the present invention to create designated characters representing specific hygiene and/or grooming difficulties as an analogy for real world difficulties. A related object of the present invention is to relate those characters to real life difficulties. A further related object of the present invention is to encourage the purchase of products to overcome such difficulties in real life.

Another object of the present invention is to provide an entertaining story.

Still another object of the present invention is to provide a method to teach and encourage children of all ages to learn and practice good personal hygiene.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows an illustration of various story characters according to one embodiment of the present invention.

FIG. 2 shows an illustration of a scene from a story according to one embodiment of the present invention.

FIG. 3 shows an illustration of another scene from a story according to one embodiment of the present invention.

FIG. 4 shows an illustration of another scene from a story according to one embodiment of the present invention.

FIG. 5 shows an illustration of additional advertising features according to one embodiment of the present invention.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

In a preferred embodiment, the invention comprises a method to teach and encourage children of all ages to learn and practice good personal hygiene by using uniquely designated characters in a series of entertaining children's stories. In general, the designated characters may represent hygiene and/or grooming difficulties and the stories describe effective methods to overcome such difficulties.

The invention further comprises a method of advertising personal hygiene products to children and adults by creating designated characters in a series of stories representing specific hygiene and/or grooming difficulties, relating those characters to real life difficulties, and encouraging the purchase of products to overcome such difficulties in real life.

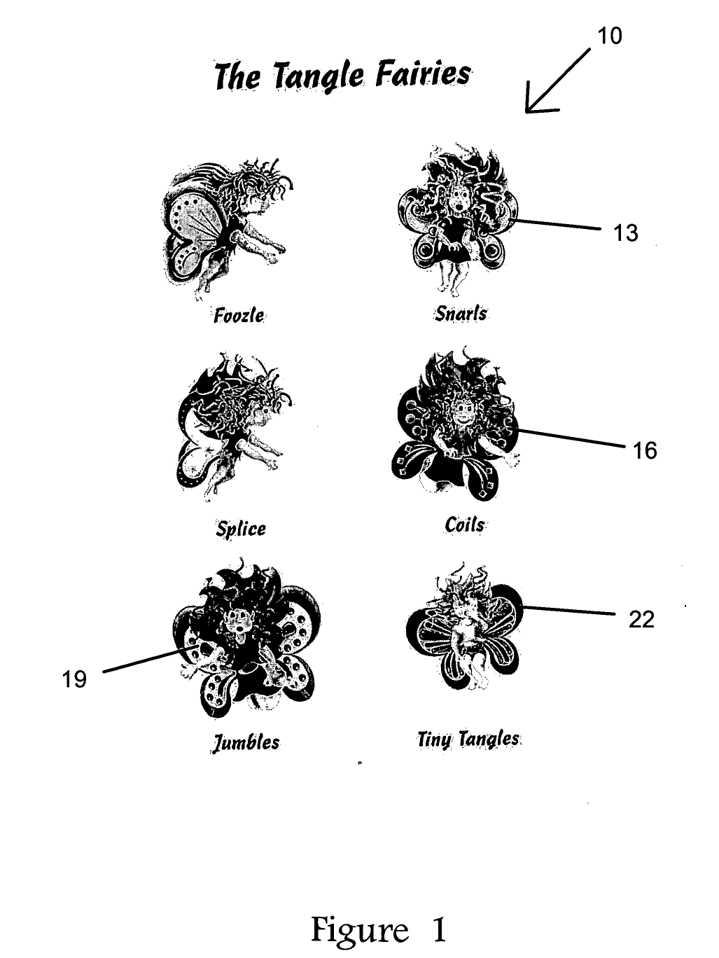

A particular example of a story according to the present invention is illustrated in the figures. FIG. 1 shows an illustration of various story characters representing problems with tangled hair, called the Tangle Fairies, indicated generally as 10. Each of a plurality of tangle fairies has a name associated with hair difficulties, such as Snarls 13, Coils 16, Jumbles 19, and Tiny Tangles 22. Of course, other appropriate names can be used. These characters, as the antagonists, represent the problem to be overcome. In some embodiments, the antagonist may be fictitious characters. Other characters, such as a parent 25 and children 28 who are afflicted with the problem, are the protagonists.

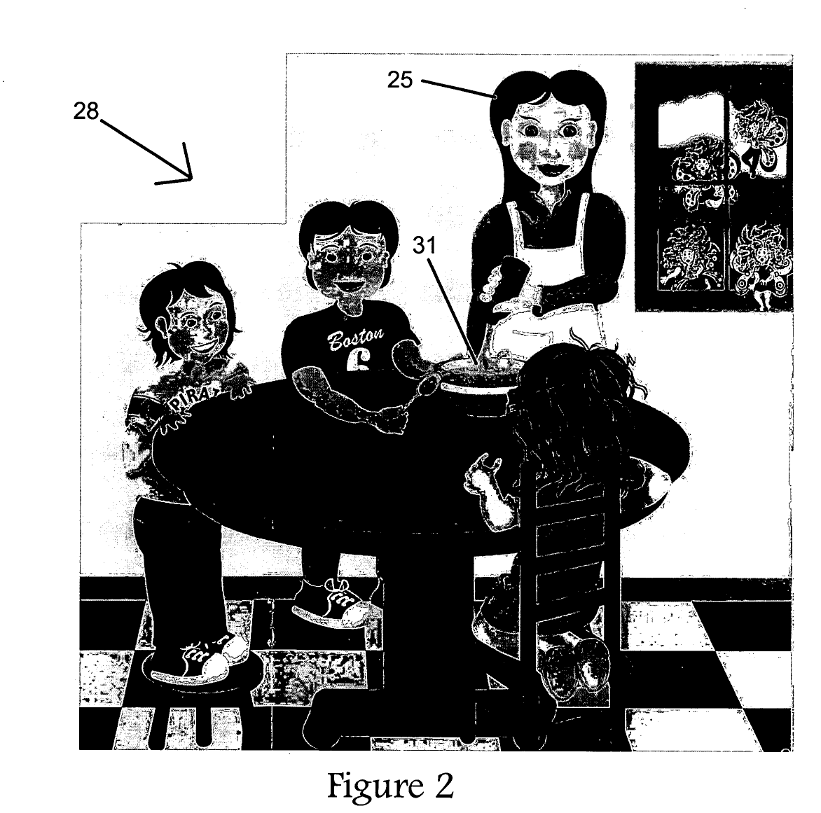

According to the present invention, an enjoyable children's story is created in which the protagonist characters develop or discover and use a product to overcome the specific difficulty presented. In the particular example described herein, the protagonists use a shampoo to counteract the effects of the tangle fairies 10. In the example illustrated in FIG. 2, the parent 25 and children 28 develop a shampoo formula 31 that will make the children's hair smooth and resistant to tangles. For advertising purposes, the shampoo may have a particular brand name.

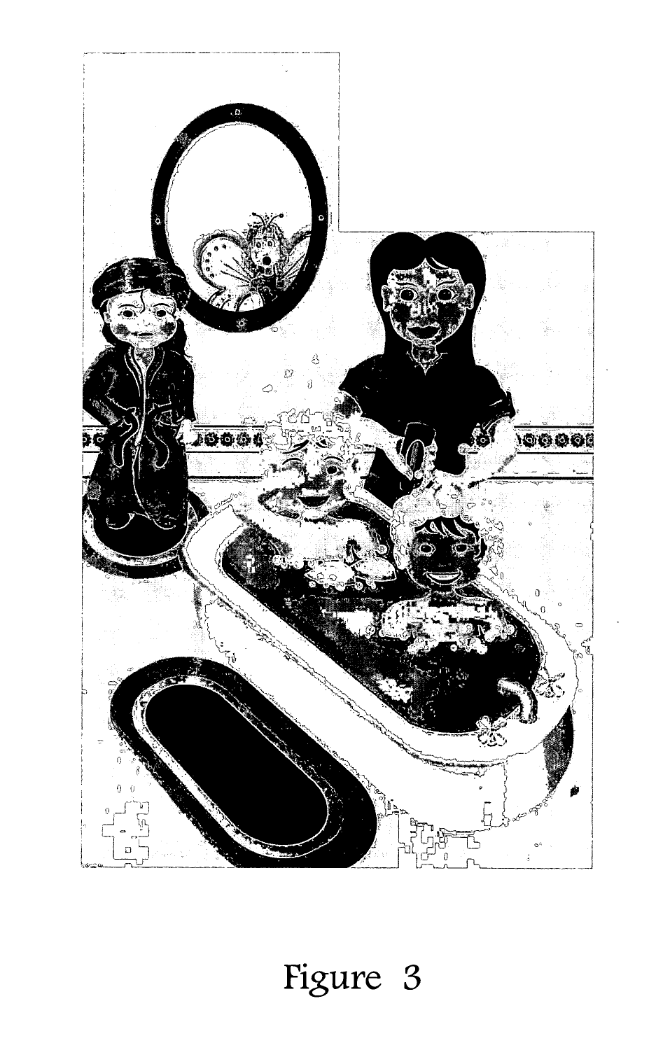

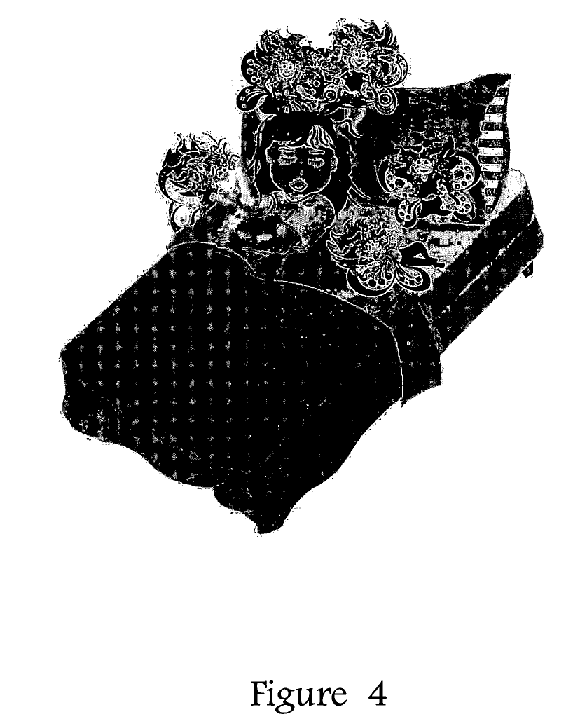

Referring to FIG. 3, the story describes the protagonist's use of the product as directed. In FIG. 4, the story continues to describe the efforts of the antagonist tangle fairies to create tangles and snarls in the children's hair while they sleep. Of course, the shampoo is effective in defeating the tangle fairies 10, resulting in no snarls and tangles upon waking. The story demonstrates that use of the product prevents the tangle fairies from creating havoc in the children's hair.

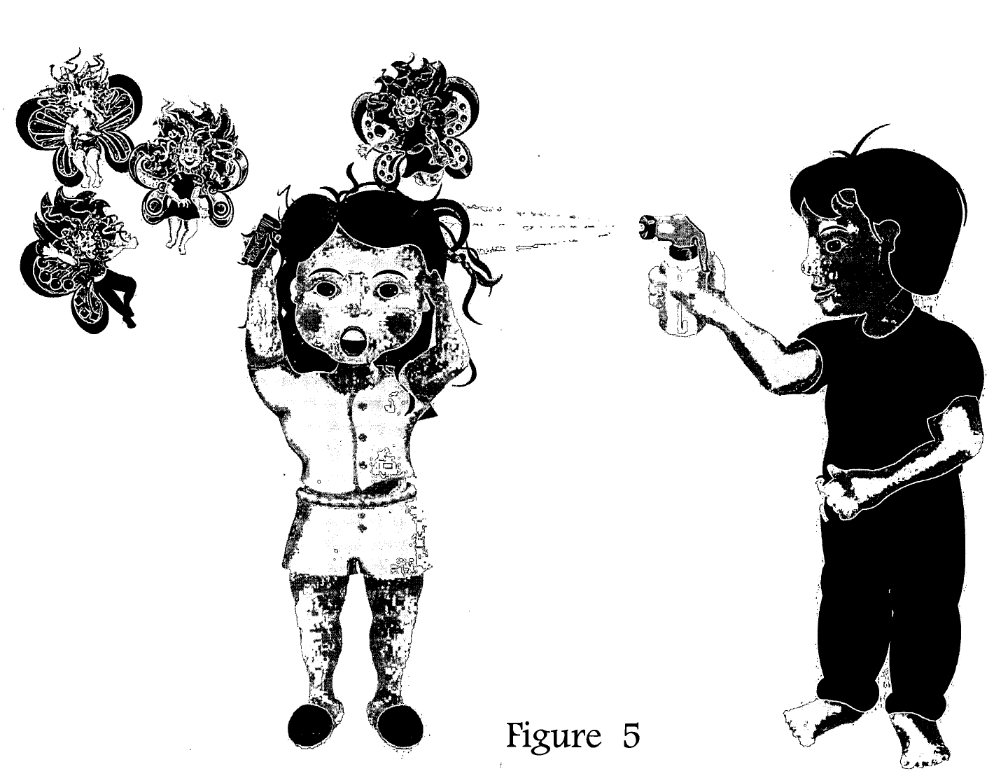

FIG. 5 illustrates an additional part of the story in which the same product can be used in another manner to defeat the tangle fairies, or in which an additional, related product can be used to defeat the tangle fairies.

A feature of the invention is the association of a story theme with a particular product or service due to the use of such product or service by the characters in the story. The particular product or service may be an object or action in the story to help the protagonist obtain a satisfactory result.

Furthermore, the invention uses simple characters to represent the antagonist in the story as an analogy to real life difficulties, enables the protagonist to encounter such analogous difficulties, and encourages the purchase of products or services to overcome such difficulties in real life.

What makes this concept new and different from traditional advertising is:

a) the focal point of this advertising format is not the brand, but rather the storyline of the story characters. Traditional advertisements have the brand as the focal point and the storyline is used solely to support the brand;

b) this advertising format engages the reader in an entertaining story, allows the characters of the story to create or discover a solution to a problem, and demonstrates the use of that solution;

c) this advertising format is designed to run with the same protagonist for many common problems in a series of stories. The goal is to identify particular grooming or hygiene issues and to relate specific products to address such grooming hygiene issues.

Revenues from the business will be generated from three (3) sources:

1) advertising: brand advertisers will pay a fee to have their brand featured in the series, (e.g., characters will use particular products to obtain a solution to a real life problem);

2) character licensing: the characters in the stories will appear in other series, toys, books, and licensing fees will be paid to the parent company; and

3) concept licensing: the concept will be licensed to ad agencies in non-U.S. countries and licensing fees will be paid to the U.S. parent company.

One or more products or services to be advertised or promoted are included in a series of separate stories that are aimed at children. Each story is centered on a specific grooming or hygiene issue in order to teach children good habits. Additionally characters may be added to the story line to represent specific hygiene and/or grooming difficulties and the stories describe effective methods to overcome such difficulties. For example, as described above, the tangle fairies represent problems with hair care and the solution is provided in a specific shampoo. Other examples of problems may include oral hygiene, washing hands, table manners, counting money, etc. Appropriate antagonist characters can be created to represent such other problems.

The stories include one or more products or services to be advertised or promoted. Express endorsement of a product or service occurs when one or more of the characters in the story expressly refers to the product or service in a favorable manner. As the same or similar characters are used in a series of stories, readers will become familiar with the characters and, to some extent, will identify with them. As the series progresses, readers develop an affinity towards one or more of the characters, increasing the readers confidence in the characters and their ability to make decisions and judgments. This increased confidence and affinity in the characters becomes associated with the products and services readers now identify and associate with the characters.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method of advertising, comprising:
creating a story having at least one antagonist character wherein such antagonist character represents or makes an analogy to a specific real life difficulty;
relating the antagonist characters to the real life or analogous difficulties;
creating at least one protagonist character in the story wherein such protagonist character encounters the real life difficulty; and
the protagonist character using of one or more products or services to overcome such difficulties.

2. The method of claim 1 further comprising the step of encouraging a reader of the story to use said one or more products or services to overcome similar real life difficulties encountered by the reader.

3. The method of claim 1 further comprising a series of stories with the same at least one protagonist character.

4. The method of claim 1 wherein the real life difficulty comprises a grooming issue.

5. The method of claim 1 wherein the real life difficulty comprises a hygiene issue.

6. The method of claim 1 wherein the one or more products or services comprise personal hygiene products.

7. A method of teaching personal hygiene to children, said method comprising:
creating a story having at least one antagonist character wherein such antagonist character represents or makes an analogy to a specific real life difficulty;
relating the antagonist characters to the real life or analogous difficulties;
creating at least one protagonist character in the story wherein such protagonist character encounters the real life difficulty; and
demonstrating the use of one or more products or services by the protagonist character to overcome such difficulties.

8. The method of claim 7 further comprising the step of encouraging a reader of the story to use said one or more products or services to overcome similar real life difficulties encountered by the reader.

9. The method of claim 7 further comprising a series of stories with the same at least one protagonist character.

10. The method of claim 7 wherein the real life difficulty comprises a grooming issue.

11. The method of claim 7 wherein the real life difficulty comprises a hygiene issue.

12. The method of claim 7 wherein the one or more products or services comprise personal hygiene products.

13. A method of introducing a new product, said method comprising:
creating a story having at least one antagonist character wherein such antagonist character represents or makes an analogy to a specific real life difficulty;
relating the antagonist characters to the real life or analogous difficulties;
creating at least one protagonist character in the story wherein such protagonist character encounters the real life difficulty; and
in the story, said protagonist creating or discovering a new product to overcome such difficulties.

14. The method of claim 13 further comprising the step of encouraging a reader of the story to use said new product to overcome similar real life difficulties encountered by the reader.

15. The method of claim 13 further comprising a series of stories with the same at least one protagonist character.

16. The method of claim 13 wherein the real life difficulty comprises a grooming issue.

17. The method of claim 13 wherein the real life difficulty comprises a hygiene issue.

18. The method of claim 13 wherein the new product comprises a personal hygiene product.
